(19) United States
(12) Patent Application Publication
(10) Pub. No.: US 2003/0038086 A1
(43) Pub. Date: Feb. 27, 2003

(54) Method and apparatus of increasing the service life of metalworking fluids

(75) Inventors: Kai Krueger, Neu-Isenburg (DE); Johann Mehlstaeubl, Stuttgart (DE); Werner Sternad, Stuttgart (DE); Iris Trick, Neuenbuerg (DE)

Correspondence Address: CROWELL & MORING LLP, INTELLECTUAL PROPERTY GROUP, P.O. BOX 14300, WASHINGTON, DC, 20044-4300, US

(73) Assignee: DaimlerChrysler AG.

(21) Appl. No.: 10/209,971

(22) Filed: Aug. 2, 2002

(30) Foreign Application Priority Data
Aug. 3, 2001 (DE) 101 38 113.1

(51) Int. Cl. C02F 1/02

(52) U.S. Cl. 210/764; 210/175

(57) ABSTRACT

A method of increasing the service life of metal working fluids by at least partially inactivating microorganisms in the metalworking fluids includes heating metal working fluids to at least the minimum temperature at which the microorganisms are inactivated on reaching a pre-determined cell density of organic microorganisms.

This application claims the priority of German Patent Document No. 101 38 113.1, filed Aug. 3, 2001, the disclosure of which is expressly incorporated by reference herein.

### BACKGROUND AND SUMMARY OF THE INVENTION

The invention relates to a method and apparatus of increasing the service life of metalworking fluids, in particular oil-in-water emulsions in which the microorganisms are at least partially inactivated.

The range of microorganisms in metalworking fluids extends from bacteria via fungi to yeasts. The most frequently found bacteria are Gram-negative non-fermenting species, since these have fewer requirements in aqueous environments and for the most part are facultative anaerobes, the microorganisms that have the ability, because of their metabolism, to exist not only in aerobic conditions, but also in anaerobic conditions.

Microbial contamination can lead to emulsion breaking and to the corrosion of workpieces. System blockages may occur due to fungal mycelia or to altered viscosity of the processing substances owing to high biomass concentration.

A highly contaminated metalworking fluid containing 10⁶ to 10⁸ colony forming units per millilitre (cfu/ml) leads not only to adverse effects in the plant system, but can also represent a health hazard to workers. Therefore, additional protective measures for the workers are required.

As a defense against the hazards, currently metalworking fluids are mostly preserved by biocides. Thus, for preservation of the fluids, hexahydrotriazine (HHT), for example, is used as a biocide, since it is a slow-release formaldehyde compound having an exceedingly broad spectrum of activity. Since the use of HHT must be declared, its use is costly and no longer desirable.

As a replacement for HHT, other slow-release formaldehyde compounds can be used. Their spectra of activity, however, are not nearly as wide. Up to 20 biocides are used. In addition to these compounds, iodocarbamates must be employed as fungicides. Here also, the costs are very high.

In general, biological treatment of process waters is made more difficult by the use of biocides. In addition, biocides can contain substances which promote foam formation during process water treatment and thus incur additional costs. Furthermore, the development of resistance among the organisms requires regular changes of products.

It is an object of the present invention to develop a method by which, with lower overall costs, the content of active microorganisms in metalworking fluids can be kept to an acceptable value, in particular below 10² cfu/ml.

The object is achieved according to the invention by a method described and claimed hereinafter. The shock-heating of the metalworking fluid inactivates, in particular destroys, many of the microorganisms. As a result, the population of the remaining microorganisms remains after the treatment below a critical value beyond which the abovementioned consequences occur.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a diagram of microbial reduction as a function of time at 108° C.

FIG. 2 shows a diagram of microbial reduction as a function of time at 900° C.

FIG. 3 shows a diagram of the change in cell count as a function of time during the treatment of mixed populations from metalworking fluid. Treatment temperatures 88, 90, 92 and 95° C.

### DETAILED DESCRIPTION OF THE DRAWINGS

According to the present invention, a heat exchanger is used for reducing the microbial count. By crossing the liquid streams, 80% to 90% of the energy can be recovered.

A combination of three heat exchanger modules allows heating to above 100° C. The processing material is heated to the desired temperature in the first module. In the central module, this temperature is kept constant for a defined period and in the third module the metalworking fluid is cooled to operating temperature.

The experiments were carried out with a metalworking fluid without preservative. The metalworking fluid was contaminated with frozen microorganisms so as to keep a concentration of 10⁵ cells/millilitre. The same population was used for all experiments.

In addition to the hot-holding section, the metalworking fluid flow rate was varied via a gear pump. The heating module of the heat exchanger was operated with steam generated by a steam generator.

For the inactivation experiments, a capillary tube heat exchanger was used, which is designed for flow rates up to 120 litres per hour. In this case there is a tube arranged within the dimensions of which establish, in addition to the volumetric flow rate etc., the hot-holding time of the metalworking fluid and thus the period of temperature exposure.

### EXAMPLE 1

The experiments using 18 mm×515 mm open hot-holding section were carried out using central temperatures of 123° C. to 146.5° C. and flow rates of 8 l/h to 67 l/h. The hot-holding times are between 59.2 and 4.75 seconds. Microorganism counts were determined via direct spreading. In none of the experiments was there any growth of colonies. The samples of the emulsions prepared had a microbial count of 2.2 ×10⁵ cfu/ml to 2.8 ×10⁵ cfu/ml, with the microorganism in the emulsion having been completely inactivated.

### EXAMPLE 2

(See Diagram, FIG. 1)

The central temperature was set to 108° C. At a flow rate between 8 l/h and 52.2 l/h, all vegetative microorganisms and spores are destroyed. At flow rates between 66.8 l/h and 100.5 l/h, the microbial count increased drastically. At a residence time of 0.4 seconds, at 108° C., only 48% of the original microorganisms are inactivated.

This fact can be seen from the diagram of FIG. 1, in which the residence time of the metalworking fluid is plotted against colony forming units per millilitre (cfu/ml).

### EXAMPLE 3

At a steam pressure of 2.0 bar, a central temperature of 121° C. is established. At this temperature, at hot-holding times which are less than 0.6 seconds, not all microorganisms are destroyed. At a hot-holding time of 0.6 seconds, 5 cfu/ml were detectable, and at a hot-holding time of 0.4 seconds, the microbial count is 7.6 ×10⁴ cfu/ml. The values resulting therefrom are shown in the table below.

| Temperature [° C.] | Hot-holding time [s] | LN(N/No) |
|---|---|---|
| 121 | 0.4 | −0.63 |
| 120 | 0.6 | −10.25 |
| 121.5 | 1.1 | |
| 119.5 | 5.0 | |

As can be seen from the table, the hot-holding time for total inactivation at 121° C. is in the range between 1.1 seconds and 0.6 seconds.

### EXAMPLE 4

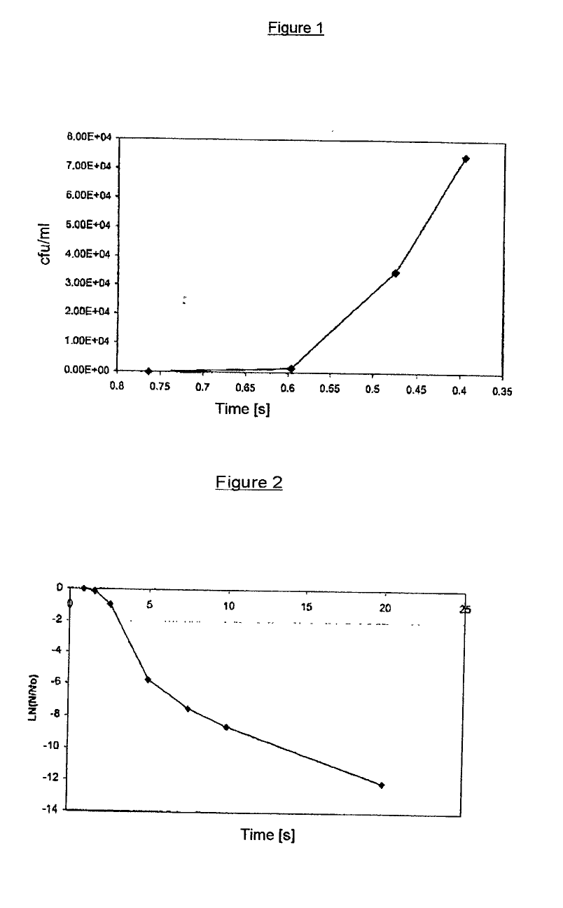

(FIG. 2)

In this experiment, the microorganism-contaminated metalworking fluid was heated in a vessel to 90° C., and with conditions otherwise the same as in Example 2, the temperature was set to 90° C.

In summary, it is possible at temperatures around 110° C. to destroy microorganisms in heat exchanger systems with a hot-holding time of less than one second. Furthermore, it is expedient that the metalworking fluid which is fouled during use is cleaned in advance from swarf and/or machine oil and the like and is then heated. It is also advantageous to filter the heat-treated metalworking fluid, as a result of which, dead fungal mycelia can be removed.

### EXAMPLE 5

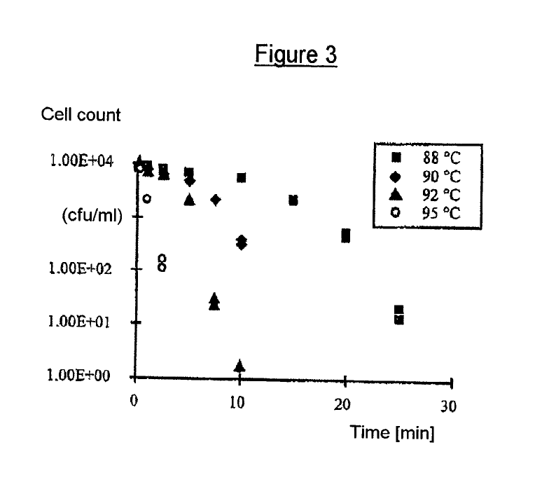

(FIG. 3)

In this experiment, microorganism-contaminated metalworking fluid was heated in a vessel to 88, 90, 92 and 95° C. It may be seen from the time course that inactivation occurred during treatment at different rates. This may be due to the presence of differing organisms and development stages. Overall, it was also found here that the time required for destroying the microorganisms decreases with increasing temperature.

Damage or functional impairment of the metalworking fluid was not observed.

What is claimed

1. A method of increasing the service life of metal working fluids by at least partially inactivating microorganisms in the metalworking fluids, the method comprising:
on reaching a pre-determined cell density of organic microorganisms, heating metal working fluids to at least the minimum temperature at which the microorganisms are inactivated.

2. The method according to claim 1, wherein the step of heating the metal working fluid includes heating the metal working fluid to at least the minimum temperature at which the microorganisms are destroyed.

3. The method according to claim 1, wherein the step of heating the metal working fluid includes heating the metalworking fluid to a temperature between 65° C. and 150° C., inclusive.

4. The method according to claim 3, wherein the step of heating the metal working fluid includes heating the metalworking fluid to 100° C.

5. The method according to claim 1, wherein the step of heating the metal working fluid includes heating the metal working fluid for a period of time between 1 second and 4 seconds, inclusive.

6. The method according to claim 1, wherein the step of heating the metal working fluid includes heating the metalworking fluid while it is flowing.

7. The method according to claim 1, further comprising cleaning the metalworking fluid before heating the metal working fluid.

8. The method according to claim 7, wherein the step of cleaning the metalworking fluid includes cleaning at least one of swarf and machine oil from the metal working fluid.

9. Apparatus for increasing the service life of metal working fluids by at least partially inactivating microorganisms in the metalworking fluids, the method comprising:
means for heating metal working fluids to at least the minimum temperature at which the microorganisms are inactivated when a pre-determined cell density of organic microorganisms is reached.

10. The apparatus according to claim 9, wherein the means for heating metal working fluids includes means for heating the metal working fluid to at least the minimum temperature at which the microorganisms are destroyed.

11. The apparatus according to claim 9, wherein the means for heating metal working fluids includes means for heating the metalworking fluid to a temperature between 65° C. and 150° C., inclusive.

12. The apparatus according to claim 11, wherein the means for heating metal working fluids includes means for heating the metalworking fluid to 100° C.

13. The apparatus according to claim 9, wherein the means for heating metal working fluids includes means for heating the metal working fluid for a period of time between 1 second and 4 seconds, inclusive.

14. The apparatus according to claim 9, wherein the means for heating metal working fluids includes means for heating the metalworking fluid while it is flowing.

15. The apparatus according to claim 9, further comprising means cleaning the metalworking fluid before heating the metal working fluid.

16. The apparatus according to claim 15, wherein the means for cleaning metal working fluids includes means for cleaning at least one of swarf and machine oil from the metal working fluid.
